(19) United States
(12) Patent Application Publication
(10) Pub. No.: US 2015/0020714 A1
(43) Pub. Date: Jan. 22, 2015

(54) HYDRAULIC COMPOSITION WITH LOW CLINKER CONTENT

(71) Applicant: LAFARGE, Paris (FR)

(72) Inventors: Mylene Martin, Saint Quentin Fallavier (FR); Elise Bony, Saint Quentin Fallavier (FR); Arnaud Schwartzentruber, Genas (FR)

(73) Assignee: LAFARGE, Paris (FR)

(21) Appl. No.: 14/382,987

(22) PCT Filed: Mar. 1, 2013
(86) PCT No.: PCT/EP2013/054140

§ 371 Date: Sep. 4, 2014

(30) Foreign Application Priority Data
Mar. 8, 2012 (FR) 1252095

(51) Int. Cl. C04B 7/02

(52) U.S. Cl. CPC C04B 7/02
USPC 106/709

(57) ABSTRACT

A hydraulic binder including in parts by mass:
(a) 40 to 70 parts of a Portland clinker;
(b) 30 to 60 parts of fly ash;
(c) optionally up to 30 parts of an inorganic material other than clinker or than fly ash;
(d) 2.5 to 15 parts of an alkali metal salt expressed in parts of equivalent-Na₂O relative to 100 parts of fly ash; and
(e) 2 to 14 parts of sulphate expressed in parts of SO₃ relative to 100 parts of clinker;
the fly ash having a Dv97 less than or equal to 40 μm, and the sum of (a), (b) and (c) being equal to 100.

The invention relates to a hydraulic binder and a hydraulic composition with low clinker content, as well as to a process for preparation and uses of such a hydraulic composition.

A known problem for hydraulic compositions is the high emission level of carbon dioxide during their production, and mainly during the production of the Portland clinker. A known solution to the emission problem of carbon dioxide is to replace part of the Portland clinker comprised in the hydraulic compositions by mineral additions. Consequently, the hydraulic compositions with low clinker content have a high <<C/K>> ratio, <<C>> being the quantity of binder, that is, the quantity of clinker and mineral additions, and <<K>> being the quantity of clinker. One of the frequently-used mineral additions to replace part of the Portland clinker is fly ash.

A known problem of hydraulic compositions having a high C/K ratio, and in particular those comprising fly ash, is the decrease of compressive strength measured 28 days after the hydraulic composition has been mixed, compared to a cement of type CEM I according to the EN 197-1 Standard of February 2001.

The addition of an alkali metal salt to a hydraulic composition having a high C/K ratio is a known process, but it is a solution to solve the problem of the decrease of the early-age compressive strength, in particular the compressive strength generally measured 24 hours after the hydraulic composition has been mixed. Furthermore, the drawback of this solution is that it decreases the compressive strength measured 28 days after the hydraulic composition has been mixed, in particular for the hydraulic compositions comprising fly ash as the mineral addition.

Moreover, a known process to increase the reactivity of a material is to increase its fineness. However, this effect, called the <<fineness effect>>, is unfortunately not often sufficient by itself to satisfactorily increase the compressive strength measured 28 days after a hydraulic composition comprising this material has been mixed.

In order to meet the requirements of users it has become necessary to find another means of increasing the compressive strength measured 28 days after the hydraulic compositions having a high C/K ratio have been mixed, in particular of the hydraulic compositions comprising fly ash as the mineral addition.

Therefore, the problem that the invention intends to solve is to provide a new means to increase the compressive strength, measured 28 days after the hydraulic compositions having a high C/K ratio and comprising fly ash as a mineral addition have been mixed.

When the properties of a new hydraulic composition are studied it may be difficult to isolate the effect induced by the modification of one single ingredient, its quantity or, for example, the size of its particles. A modification may improve one property but have a negative effect on other properties. A modification may require different modifications of other compounds to maintain or secure a desired property. When two or more compounds are modified, it is generally impossible to predict how the different properties of the composition will be affected. A long and careful experimental investigation is required. Consideration must be given to both the physical properties, for example the compressive strength and its evolution over time, and to economic and environmental factors, for example, costs related to the different ingredients of the composition and the quantity of carbon dioxide generated by the production of the clinker.

Unexpectedly, the inventors have shown that it is possible to use an alkali metal salt combined with a high fineness fly ash to improve the compressive strength, measured 28 days after the hydraulic composition having a high C/K ratio and comprising a fly ash has been mixed.

With this aim, the present invention proposes a hydraulic binder comprising a Portland clinker, a fly ash having a selected fineness, optionally an inorganic material, an alkali metal salt and calcium sulphate.

The present invention intends to provide new hydraulic binders and hydraulic compositions which have one or more of the following characteristics:

reduced emissions of CO₂ related to the production of the composition according to the invention given that the quantity of clinker is less than that of ordinary concrete, in particular, a C25/30 type of concrete. A C25/30 type of concrete is a concrete according to the EN 206-1 Standard, whose compressive strength, which is measured 28 days after the hydraulic composition has been mixed, on a 16 cm×32 cm cylinder, is at least 25 MPa, and when the compressive strength is measured on a 15 cm×15 cm cube it is at least 30 MPa.

the present invention makes it possible to reduce the quantity of Portland clinker whilst keeping a compressive strength, measured 28 days after the hydraulic composition has been mixed, equivalent to that of the composition before the quantity of Portland clinker was reduced.

the observed effect between the alkali metal salt used in the proportions given according to the invention and the increase of the fineness of the fly ash, makes it possible to substantially and unexpectedly increase the compressive strength measured 28 days after the hydraulic compositions having a high C/K ratio have been mixed.

the present invention makes it possible to obtain a hydraulic composition having a compressive strength of at least 35 MPa, which is measured 28 days after the hydraulic composition has been mixed.

the present invention makes it possible to use less fly ash and, for example more material containing calcium carbonate, e.g. limestone, and still obtain the same performances as well as a savings in terms of cost.

In the present description, including the accompanying claims, the term <<one>> is to be understood as <<one or more>>.

The present invention relates to a hydraulic binder comprising in parts by mass:
(a) 40 to 70 parts of Portland clinker;
(b) 30 to 60 parts of fly ash;
(c) optionally, up to 30 parts of an inorganic material other than clinker or than fly ash;
(d) 2.5 to 15 parts of an alkali metal salt expressed in parts of equivalent-Na₂O relative to 100 parts of fly ash; and
(e) 2 to 14 parts of sulphate expressed in parts of SO₃ relative to 100 parts of clinker;
   the fly ash having a Dv97 less than or equal to 40 μm and the sum of (a), (b) and (c) being equal to 100.

A hydraulic binder is a material which sets and hardens by hydration. Preferably, the hydraulic binder is a cement.

Portland clinker, as defined in the NF EN 197-1 Standard of February 2001, is obtained by clinkering at high temperature a mixture comprising limestone and, for example, clay.

Preferably, the Portland clinker has a Blaine specific surface greater than or equal to 3500 cm²/g, more preferably greater than or equal to 5500 cm²/g.

The Portland clinker used according to the present invention may be ground and/or separated (by a dynamic separator) in order to obtain a clinker having a Blaine specific surface greater than or equal to 5500 cm²/g. This clinker may be qualified as being ultrafine. The clinker may, for example, be ground in two steps. In a first step, the clinker may be ground to a Blaine specific surface of 3500 to 4000 cm²/g. A high-efficiency separator, referred to as second or third generation, may be used in this first step to separate the clinker having the desired fineness and the clinker needing to be returned to the grinder. In a second step, the clinker may go first through a very high efficiency separator, referred to as very high fineness (VHF), in order to separate the clinker particles having a Blaine specific surface greater than or equal to 5500 cm²/g and the clinker particles having a Blaine specific surface less than 5500 cm²/g. The clinker particles having a Blaine specific surface greater than or equal to 5500 cm²/g may be used per se. The clinker particles having a Blaine specific surface less than 5500 cm²/g may be ground again until the required Blaine specific surface is obtained. The grinders, which may be used in the two steps are, for example, a ball mill, a vertical mill, a roller press, a horizontal mill (for example a Horomill©) or a stirred vertical mill (for example a Tower Mill).

The size of the particles of fly ash available on the market is generally greater than 40 μm, and even greater than 100 μm. The fly ash used according to the present invention is generally ground and separated to reduce the particle size to a desired Dv97, for example, using the method described above for the clinker.

Preferably, the fly ash used according to the present invention has a Dv97 less than or equal to 30 μm.

The <<Dv97>> is the 97^{th} percentile of the size distribution of the particles, by volume, that is, 97% of the particles have a size that is less than or equal to Dv97 and 3% of the particles have a size that is greater than Dv97. The Dv90 is defined in a similar manner.

Preferably, if the fly ash comprises more than 10% of reactive CaO, then it has a Dv97 greater than or equal to 15 μm, more preferably greater than or equal to 20 μm. The reactive CaO is the total CaO of the binder minus the CaO coming from the CaCO₃, calculated on the basis of the measured content of CO₂, and minus the CaO coming from the CaSO₄, calculated on the basis of the measured content of SO₃ minus the SO₃ carried by the alkali metal salts.

Preferably, the fly ash used according to the present invention comprises less than 10% of reactive CaO and/or comprises a quantity of SiO₂+Al₂O₃+Fe₂O₃ greater than 50%, more preferably greater than 70%.

Fly ash is generally a pulverulent particle comprised in fume from thermal power plants which are fed with coal. It is generally recovered by electrostatic or mechanical precipitation.

The chemical composition of a fly ash mainly depends on the chemical composition of the unburned carbon and on the process used in the thermal power plant where it came from. The same can be said for its mineralogical composition.

Preferably, the fly ash used according to the present invention is selected from those described in the EN 197-1 Standard of February 2001 and in the ASTM C 618 Standard of 2008. The fly ash may be, for example, of type V or W according to the EN 197-Standard of February 2001, of class F or C according to the ASTM C 618 Standard of 2008, or mixtures thereof. Preferably, the fly ash is selected from the fly ash of the V type according to the EN 197-1 Standard of February 2001, of class F according to the ASTM C 618 Standard of 2008, and mixtures thereof.

A fly ash of type V comprises less than 10.0% by mass of reactive CaO, at most 1.0% by mass of free CaO and at least 25.0% by mass of reactive SiO₂.

A fly ash of type W comprises at least 10.0% by mass of reactive CaO. A fly ash of type W which comprises from 10.0 to 15.0% of reactive CaO also comprises at least 25.0% by mass of reactive SiO₂.

A fly ash of class C comprises at least 50.0% of SiO₂+Al₂O₃+Fe₂O₃, at most 5.0% of SO₃ and a loss on ignition of at most 6.0%.

A fly ash of class F comprises at least 70.0% of SiO₂+Al₂O₃+Fe₂O₃, at most 5.0% of SO₃ and a loss on ignition of at most 6.0%.

Particle size distributions and particle sizes less than approximately 200 μm are measured using a Malvern MS2000 laser granulometer. Measurement is carried out in ethanol. The light source consists of a red He—Ne laser (632 nm) and a blue diode (466 nm). The optical model is that of Mie and the calculation matrix is of the polydisperse type.

The apparatus is calibrated before each working session by means of a standard sample (Sibelco C10 silica) for which the particle size distribution is known.

Measurements are carried out with the following parameters: pump speed: 2300 rpm and stirrer speed: 800 rpm. The sample is introduced in order to establish an obscuration from 10 to 20%. Measurement is carried out after stabilisation of the obscuration. Ultrasound at 80% is applied for 1 minute to ensure the de-agglomeration of the sample. After approximately 30 s (for possible air bubbles to clear), a measurement is carried out for 15 s (15000 analysed images). The measurement is repeated at least twice without emptying the cell to verify the stability of the result and elimination of possible bubbles.

All values given in the description and the specified ranges correspond to average values obtained with ultrasound.

Particle sizes greater than 200 μm are generally determined by sieving.

The inorganic material used in the hydraulic binder of the invention is generally a material in the form of particles having a Dv90 less than or equal to 200 μm, and preferably a Dv97 less than or equal to 200 μm. The inorganic material may be natural or derived from an industrial process. The inorganic material includes materials which are inert or have low hydraulic or pozzolanic properties. They preferably do not have a negative impact on the water demand of hydraulic binders, on the compressive strength of hydraulic compositions and/or on the anti-corrosion protection of reinforcements.

Preferably, the inorganic material used according to the present invention is selected from mineral additions. Mineral additions are for example pozzolanic materials (e.g. as defined by the “Cement” NF EN 197-1 Standard of February 2001, paragraph 5.2.3), silica fume (e.g. as defined by the “Cement” NF EN 197-1 Standard of February 2001, paragraph 5.2.7 or as defined by the “Concrete” prEN 13263:1998 or NF P 18-502 Standards), slags (e.g. as defined by the <<Cement>> NF EN 197-1 Standard of February 2001, paragraph 5.2.2 or as defined by the “Concrete” NF P 18-506 Standard), calcined shale (e.g. as defined by the <<Cement>> NF EN 197-1 Standard of February 2001, paragraph 5.2.5), materials containing calcium carbonate, for example limestone (e.g. as defined by the “Cement” NF EN 197-1 Standard of February 2001 paragraph 5.2.6 or as defined by the “Concrete” NF P 18-506 Standard), siliceous additions (e.g. as defined by the “Concrete” NF P 18-506 Standard), metakaolins or mixtures thereof.

Preferably, the inorganic material used according to the present invention is selected from mineral additions, as defined above, that is, the pozzolanic materials, the silica fume, the slags, the calcined shale, the materials containing calcium carbonate (for example limestone), the siliceous additions, the metakaolins and mixtures thereof.

Preferably, the inorganic material is a material containing calcium carbonate (for example limestone), in particular a ground material containing calcium carbonate (for example ground limestone).

Although the inorganic material may be a binding material, the inorganic material is preferably an inert material, which is to say, non-binding material (without hydraulic or pozzolanic activity). An inert inorganic material is particularly suitable for optimisation purposes (in particular in terms of cost) of the hydraulic compositions according to the invention.

Preferably, the alkali metal salt used according to the present invention is selected from sodium, potassium, lithium salts and mixtures thereof. More preferably, the alkali metal salt used according to the present invention is a sodium salt.

Preferably, the alkali metal salt used according to the present invention is water soluble: the water solubility is preferably greater than 2 g/100 ml at 20° C.

Preferably, the anion in the alkali metal salt used according to the present invention is sulphate, nitrate, chloride, silicate, hydroxide and mixtures thereof. Preferably, the anion in the alkali metal salt used according to the present invention is sulphate. Preferably, the alkali metal salt used according to the present invention comprises sodium sulphate.

Generally, within the range of equivalent-Na₂O described according to the present invention, the higher the content of alkali metal salt, the better the compressive strength.

The alkali metal salts in the different materials comprised in the binder should be taken into account to determine the content of alkali metal salt used according to the present invention.

The content, in grams, of equivalent-Na₂O in the binder is determined according to the following formula:

Na₂Oeq=Na₂O+(0.658×K₂O)+(2.08×Li₂O)
wherein Na₂O, K₂O and Li₂O respectively represent the mass of Na₂O, K₂O and Li₂O in grams.

It is to be understood that a similar calculation may be used for the other oxides of alkali metal using the molecular masses of their oxides relative to that of Na₂O.

The sulphate used according to the present invention may, for example, be provided by calcium sulphate. Calcium sulphate used according to the present invention includes gypsum (calcium sulphate dihydrate, CaSO₄.2H₂O), hemi-hydrate (CaSO₄.½H₂O), anhydrite (anhydrous calcium sulphate, CaSO₄) or mixtures thereof. The gypsum and anhydrite exist in the natural state. Calcium sulphate produced as a by-product of certain industrial processes may also be used.

Preferably, the sulphate used according to the present invention is provided by more than one source, for example calcium sulphate and an alkali metal sulphate, such as sodium sulphate. Different sources of sulphate have different solubilities and dissolution speeds. This difference makes it possible to have sulphate in solution available at different moments after the mixing.

The sulphates in the different materials comprised in the binder should be taken into account to determine the content of sulphates used according to the present invention.

The invention also relates to a hydraulic composition which comprises water and a hydraulic binder as described herein above.

A hydraulic composition generally comprises a hydraulic binder and water, optionally aggregates, optionally a mineral addition and optionally an admixture. The hydraulic compositions according to the invention include both fresh and hardened compositions, for example a cement slurry, a mortar or a concrete.

Preferably, the hydraulic composition according to the invention has an effective water/binder ratio of 0.25 to 0.7.

The effective water is the water required to hydrate a hydraulic binder and to provide fluidity for a fresh hydraulic composition. The total water represents the totality of the water present in the mix (at the time of mixing) and comprises the effective water and the water absorbed by the aggregates. Effective water and its calculation are discussed in the EN 206-1 Standard of October 2005, page 17, paragraph 3.1.30.

The quantity of absorbable water is deduced from the absorption coefficient of the aggregates measured according to the NF 1097-6 Standard of June 2001, page 6, paragraph 3.6 and the associated annex B. The water absorption coefficient is the ratio of the increase in mass of a sample of aggregates, initially dry and then submerged in water for 24 hours, relative to its dry mass due to the water penetrating into the pores accessible to the water.

Preferably, the hydraulic composition according to the invention further comprises aggregates.

Aggregates used in the compositions according to the invention include sand (whose particles generally have a maximum size (Dmax) less than or equal to 4 mm), and coarse aggregates (whose particles generally have a minimum size (Dmin) greater than 4 mm, and preferably a Dmax less than or equal to 20 mm).

The aggregates include calcareous, siliceous, and silico-calcareous materials. They include natural, artificial, waste and recycled materials. The aggregates may also comprise, for example, wood.

The hydraulic composition may be used directly on jobsites in the fresh state and poured into formwork adapted to a given application, or used in a pre-cast plant, or used as a coating on a solid support.

The hydraulic binders and the hydraulic compositions comprise several different components of various sizes. It may be advantageous to associate components whose respective sizes are complementary to each other, which is to say, the components with the smallest particles can slip in between the components with the larger particles. For example, the inorganic material used according to the present invention may be used as filling material, which means that it may fill in voids between other components whose particles are larger in size.

The hydraulic composition according to the invention may, for example, comprise one of the admixtures described in the EN 934-2 (September 2002), EN 934-3 (November 2009) or EN 934-4 (August 2009) Standards. Advantageously, the hydraulic composition according to the invention comprises at least one admixture for a hydraulic composition: an accelerator, an air-entraining agent, a viscosity-modifying agent, a retarder, a clay-inerting agent, a plasticizer and/or a superplasticizer. In particular, it is useful to include a polycarboxylate superplasticizer, for example, a quantity of from 0.05 to 1.5%, preferably from 0.1 to 0.8% by mass.

Clay-inerting agents are compounds which permit the reduction or prevention of the harmful effects of clays on the properties of hydraulic binders. Clay-inerting agents include those described in WO 2006/032785 and WO 2006/032786.

The term superplasticizer as used in the present description and the accompanying claims is to be understood as including both water reducers and superplasticizers as described in the Concrete Admixtures Handbook, Properties Science and Technology, V.S. Ramachandran, Noyes Publications, 1984.

A water reducer is defined as an admixture which reduces the amount of mixing water of a concrete for a given workability by typically 10-15%. Water reducers include, for example lignosulphonates, hydroxycarboxylic acids, glucides, and other specialized organic compounds, for example glycerol, polyvinyl alcohol, sodium alumino-methyl-siliconate, sulfanilic acid and casein.

Superplasticizers belong to a new class of water reducers, which are chemically different to the typical water reducers and are capable of reducing water contents by approximately 30%. The superplasticizers have been broadly classified into four groups: sulphonated naphthalene formaldehyde condensate (SNF) (generally a sodium salt); sulphonated melamine formaldehyde condensate (SMF); modified lignosulfonates (MLS); and others. More recent superplasticizers include polycarboxylic compounds, for example, polycarboxylates, for example, polyacrylates. A superplasticizer is preferably a new generation superplasticizer, for example a copolymer containing polyethylene glycol as a graft chain and carboxylic functions in the main chain, for example, a polycarboxylic ether. Sodium polycarboxylate-polysulphonates and sodium polyacrylates may also be used. Phosphonic acid derivatives may also be used. The amount of superplasticizer required generally depends on the reactivity of the cement. The lower the reactivity of the cement, the lower the amount of superplasticizer required. In order to reduce the total alkali salt content, the superplasticizer may be used in the form of a calcium salt rather than a sodium salt.

The invention also relates to a process for production of a hydraulic composition according to invention which comprises a step of mixing water and a Portland clinker, fly ash having a Dv97 less than or equal to 40 μm, optionally an inorganic material other than clinker or than fly ash, an alkali metal salt and sulphate in quantities as defined herein above for the hydraulic composition according to the invention.

Mixing may be carried out, for example, by known methods.

According to an embodiment of the invention, the hydraulic binder is prepared during a first step, and the aggregates and water are added during a second step.

According to another embodiment of the process according to the present invention, it is possible to add each of the elements described above separately.

It is also possible to use a cement of the type CEM I according to the EN 197-1 Standard of February 2001, which comprises Portland clinker and calcium sulphate, or a blended cement, which may comprise Portland clinker, calcium sulphate and at least one mineral addition, for example slag and/or a material containing calcium carbonate (for example limestone). If a CEM I type of cement or a blended cement is used, it is then necessary to adjust the respective quantities of each of the elements in order to obtain the hydraulic binder or the hydraulic composition according to the present invention.

The hydraulic composition according to the present invention may be shaped to produce a shaped article for the construction field, after hydration and hardening. The invention also relates to such a shaped article, which comprises a hydraulic binder as described above. Shaped articles for the construction field include, for example, a floor, a screed, a foundation, a wall, a partition wall, a ceiling, a beam, a work top, a pillar, a bridge pier, a block of concrete, a conduit, a post, a stair, a panel, a cornice, a mould, a road system component (for example a border of a pavement), a roof tile, a surfacing (for example of a road or a wall), a plaster board, an insulating component (acoustic and/or thermal).

In the present description, including the accompanying claims, unless otherwise specified, percentages are by mass.

The following examples are provided for the invention purely for illustrative and non-limiting purposes.

### EXAMPLES

### Raw Materials

Cement: CEM I 52.5 cement (from Lafarge Cement—cement plant of Saint-Pierre La Cour, called <<SPLC>>).

In the formulae using the FA-1 and FA-4 fly ash, the cement had 97% by mass of Portland clinker, 0.75% by mass of equivalent-Na₂O, 3.47% by mass of SO₃, a Dv97 of 19 μm and a Blaine specific surface of 6270 cm²/g.

In the formulae using the FA-2 and FA-3 fly ash, the cement had 96% by mass of Portland clinker, 0.74% by mass of equivalent-Na₂O 3.86% by mass of SO₃, a Dv97 of 19 μm and a Blaine specific surface of 6540 cm²/g.

Fly Ash: fly ash from different thermal power plants, the characteristics of which are given in the tables below. The commercially available fly ash was used without prior grinding to produce the control compositions. The particle size of the commercially available fly ash was reduced by grinding using an air jet mill in association with a separator to produce the compositions used in the examples of the present invention.

FA-1: fly ash from the European thermal power plant of Megalopolis (Greece; W Type according to NF EN 197-1 Standard of February 2001), having 1.82% by mass of equivalent-Na₂O, 1.63% by mass of SO₃ and the characteristics and chemical compositions of which are given in the tables below. Before grinding the FA-1 fly ash had a Dv97 of 858 μm;

FA-2: fly ash from the American thermal power plant of Sundance (USA; F Class according to ASTM C618 Standard of 2008), having 3.70% by mass of equivalent-Na₂O, 0.20% by mass of SO₃ and the characteristics and chemical compositions of which are given in the tables below. Before grinding the FA-2 fly ash had a Dv97 of 126 μm;

FA-3: fly ash from the European thermal power plant of Cottam (UK; V Type according to NF EN 197-1 Standard of February 2001), having 2.67% by mass of equivalent-Na₂O, 0.99% by mass of SO₃ and the characteristics and chemical compositions of which are given in the tables below. Before grinding the FA-3 fly ash had a Dv97 of 190 μm;

FA-4: fly ash from the European thermal power plant of Le Havre (France; V Type according to NF EN 197-1 Standard of February 2001), having 1.68% by mass of equivalent-Na₂O, 0.69% by mass of SO₃ and the characteristics and chemical compositions of which are given in the tables below. Before grinding the FA-4 fly ash had a Dv97 of 219 μm.

Chemical composition of the Fly Ash

| | SiO2 | Al2O3 | Fe2O3 | CaO | MgO | K2O | Na2O | SO3 | TiO2 | Mn2O3 | P2O5 | Cr2O3 |
|---|---|---|---|---|---|---|---|---|---|---|---|---|
| Fly Ash | % | % | % | % | % | % | % | % | % | % | % | % |
| FA-1 | 50.59 | 18.84 | 8.44 | 11.71 | 2.83 | 1.87 | 0.59 | 1.39 | 0.84 | 0.06 | 0.25 | 0.04 |
| FA-2 | 54.70 | 23.28 | 3.82 | 10.92 | 1.08 | 0.84 | 3.15 | 0.16 | 0.67 | 0.06 | 0.08 | 0.00 |
| FA-3 | 54.54 | 21.12 | 9.38 | 3.09 | 1.75 | 2.4 | 1.09 | 0.3 | 0.88 | 0.09 | 0.3 | 0.02 |
| FA-4 | 54.69 | 26.95 | 5.09 | 2.55 | 1.07 | 1.95 | 0.4 | 0.17 | 1.43 | 0.04 | 0.46 | 0.03 |

| | | | | | | | | | | LOI | |
|---|---|---|---|---|---|---|---|---|---|---|---|
| | ZrO2 | SrO | ZnO | As2O3 | BaO | CuO | NiO | PbO | V2O5 | 975° C. | Total |
| Fly Ash | % | % | % | mg/kg | mg/kg | mg/kg | mg/kg | mg/kg | mg/kg | % | % |
| FA-1 | 0.03 | 0.07 | 0.01 | — | 574.00 | 113.00 | 296.00 | — | 427.00 | 2.40 | 100.09 |
| FA-2 | 0.05 | 0.10 | 0.00 | 12 | 4 262 | 56 | 45 | 66 | 106 | 0.92 | 100.30 |
| FA-3 | 0.04 | 0.09 | 0.02 | 84 | 1654 | 171 | 178 | 79 | 522 | 4.28 | 99.65 |
| FA-4 | 0.05 | 0.1 | 0.01 | — | 1268 | 145 | 141 | 31 | 534 | 4.81 | 100 |

Other characteristics of the fly ash

| | | Density of the | Unburnt | Blaine Specific |
|---|---|---|---|---|
| | Free CaO | solid | carbon | Surface |
| Fly Ash | (mass %) | (g/cm³) | (mass %) | (cm²/g) |
| FA-1 | 0.67 | 2.39 | 1.84 | 2181 |
| FA-1 | 0.69 | 2.64 | 2.07 | 7 574 |
| Dv97 = 25 μm | | | | |
| FA-2 | 0.17 | 2.09 | 0.12 | 3 686 |
| FA-2 | 0.37 | 2.47 | 0.16 | 5 332 |
| Dv97 = 25 μm | | | | |
| FA-2 | 0.41 | 2.61 | 0.19 | 8 551 |
| Dv97 = 10 μm | | | | |
| FA-3 | 0.13 | 2.35 | 3.39 | 3202 |
| FA-3 | 0.34 | 2.67 | 3.76 | 8 868 |
| Dv97 = 10 μm | | | | |
| FA-4 | 0.1 | 2.24 | 3.46 | 4209 |
| FA-4 | 0.17 | 2.57 | 3.32 | 6 937 |
| Dv97 = 25 μm | | | | |
| FA-4 | 0.13 | 2.60 | 3.73 | 9 772 |
| Dv97 = 10 μm | | | | |

LOI Loss on ignition

Alkali metal salt: Na₂SO₄ in powder form having laboratory-produced purity (purity at 99.98%; supplier VWR) and having 43.63% by mass of equivalent-Na₂O and 56.37% by mass of SO₃.

Admixture: the polycarboxylate type of plasticizer sold under the commercial brand name of Prelom 300 (Supplier: BASF).

Material containing calcium carbonate: limestone sold under the commercial brand name of BL200 (Supplier: Omya).

Aggregates: the materials in the following list were used and all came from Lafarge quarries (in this list the ranges of aggregates are given in the form of d/D wherein <<d>> and <<D>> are as defined in the XPP 18-545 Standard of February 2004):
0/5 R St Bonnet sand: siliceous sand from the St Bonnet quarry;
1/5 R St Bonnet sand: siliceous sand from the St Bonnet quarry; and
5/10 R St Bonnet coarse aggregates: siliceous coarse aggregates from the St Bonnet quarry.

Effective water: 189 g of hydraulic composition.

### Mixing the Concretes

The tested concretes were produced according to the procedure described below:
1) introduce the aggregates, then the other powders (cement, slag, material containing calcium carbonate, anhydrite II and Na₂SO₄) in the mixing bowl of a planetary Rayneri R201 mixer having a vessel with a 10 L capacity and a reinforced blade in the shape of a <<sage leaf>> having a thickness of 12 mm; the raw materials have been stored at 20° C. for at least 24 hours before mixing;
2) mix at speed 1 for 30 seconds;
3) interrupt the stirring operation, open the protection grid and introduce the mixing water comprising the admixture (at 20° C.) in one single operation;
4) close the protection grid and resume the mixing operation at speed 1;
5) stop the mixer after 4 minutes of mixing; the mixing is finished.

### Performances of the Concretes According to the Invention

The performances of the concretes according to the invention were evaluated in terms of compressive strength according to the EN 12390-3 Standard. The compressive strength was measured on cylindrical specimens having a 70 mm diameter and a slenderness ratio of 2. They were produced and stored according to the EN 12390-2. Standard. The specimens were rectified before the measurements were carried out according to the EN 12390-3 Standard for the compressive strengths measured 28 days after the concrete was mixed. The specimens were coated with a mortar with a base of sulphur before the measurements were carried out according to the sulphur mortar method of the EN 12390-3 Standard for the compressive strengths measured 24 hours after the concrete was mixed. The press used for the compressive strength measurement (Controlab C12004 of 250 kN of class 1) was in accordance with the EN 12390-4 Standard. The loading up to compression failure was carried out at a speed of 3.85 kN/s (which is to say a speed of 1 MPa/s for a cylindrical specimen having a 70 mm diameter).

The results of the measurements of the compressive strength are shown in Tables 1-1 to 1-4 hereinafter. These results are the average of three measurements, rounded off to the closest tenth MPa.

The compositions 1-1 to 1-4, 2-1 to 2-4, 3-1 a 3-4 and 4-1 to 4-4 were control compositions, in which the fly ash had a Dv97 greater than 40 μm.

Each composition presented in Tables 1-1 to 1-4 hereinafter further comprised:

596 g of 0/5 R St Bonnet sand;

271 g of sand 1/5 R St Bonnet sand;

869 g of 5/10 R St Bonnet coarse aggregates; and

171 g of SPLC cement.

Table 2 hereinafter presents the interpretation of the results obtained for the mechanical strengths.

TABLE 1.1
Composition of the concretes and strengths obtained with FA-1

| | |
|---|---|
| | FA-1 |
| FA-1 | Dv97 = 25 μm |

| test n° | 1-1 | 1-2 | 1-3 | 1-4 | 1-5 | 1-6 | 1-7 | 1-8 |
|---|---|---|---|---|---|---|---|---|
| Limestone (g) | 38.7 | 44.5 | 44.5 | 44.5 | 53.2 | 59.0 | 59.0 | 59.0 |
| Fly ash (g) | 134.1 | 125.7 | 117.4 | 109.0 | 134.1 | 125.7 | 117.4 | 109.0 |
| Anhydrite II (g) | 6.1 | 0.0 | 0.0 | 0.0 | 6.1 | 0.0 | 0.0 | 0.0 |
| Na₂SO₄ (g) | 0.0 | 8.4 | 16.8 | 25.1 | 0.0 | 8.4 | 16.8 | 25.1 |
| % Na₂Oeq total mix/(FA) | 2.8 | 5.8 | 9.2 | 13.1 | 2.7 | 5.7 | 9.1 | 13.0 |
| % SO₃ total mix/(KK) | 5.9 | 6.5 | 9.3 | 12.2 | 5.9 | 6.5 | 9.3 | 12.2 |
| PCP (Prelom 300) (g) | 21.0 | 22.0 | 22.0 | 22.0 | 10.9 | 10.9 | 12.0 | 12.0 |
| 24-hour Cs (MPa) | 6.7 | 11.8 | 13.5 | 14.2 | 9.7 | 14.5 | 15.9 | 16.0 |
| 28-day Cs (MPa) | 28.5 | 31.7 | 33.3 | 33.0 | 35.5 | 39.0 | 40.9 | 42.0 |

TABLE 1.2
Composition of the concretes and strengths obtained with FA-2

| | | | | | FA-2 | | | |
|---|---|---|---|---|---|---|---|---|
| | FA-2 | | | | Dv97 = 25 μm | | | |
| test n° | 2-1 | 2-2 | 2-3 | 2-4 | 2-5 | 2-6 | 2-7 | 2-8 |
| Limestone (g) | 15.0 | 22.1 | 22.1 | 22.1 | 41.8 | 49.0 | 49.0 | 49.0 |
| Fly ash (g) | 134.1 | 125.7 | 117.4 | 109.0 | 134.1 | 125.7 | 117.4 | 109.0 |
| Anhydrite II (g) | 7.5 | 0.0 | 0.0 | 0.0 | 7.5 | 0.0 | 0.0 | 0.0 |
| Na₂SO₄ (g) | 0.0 | 8.4 | 16.8 | 25.1 | 0.0 | 8.4 | 16.8 | 25.1 |
| % Na₂Oeq total mix/(FA) | 4.7 | 7.6 | 11.0 | 15.0 | 4.6 | 7.5 | 10.9 | 14.9 |
| % SO₃ total mix/(KK) | 5.9 | 6.5 | 9.3 | 12.2 | 5.9 | 6.5 | 9.3 | 12.2 |
| PCP (Prelom 300) (g) | 1.5 | 1.5 | 1.2 | 1.2 | 2.9 | 2.7 | 2.7 | 2.4 |
| 24-hour Cs (MPa) | 9.0 | 12.9 | 13.8 | 13.2 | 8.6 | 12.9 | 15.0 | 14.4 |
| 28-day Cs (MPa) | 29.0 | 31.0 | 34.5 | 33.7 | 31.1 | 35.0 | 38.2 | 37.5 |

FA-2
Dv97 = 10 μm

| test n° | 2-9 | 2-10 | 2-11 | 2-12 |
|---|---|---|---|---|
| Limestone (g) | 49.8 | 56.9 | 56.9 | 56.9 |
| Fly ash (g) | 134.1 | 125.7 | 117.4 | 109.0 |
| Anhydrite II (g) | 7.5 | 0.0 | 0.0 | 0.0 |
| Na₂SO₄ (g) | 0.0 | 8.4 | 16.8 | 25.1 |
| % Na₂Oeq total mix/(FA) | 4.5 | 7.4 | 10.8 | 14.8 |
| % SO₃ total mix/(KK) | 5.9 | 6.5 | 9.3 | 12.2 |
| PCP (Prelom 300) (g) | 3.3 | 3.0 | 2.7 | 2.7 |
| 24-hour Cs (MPa) | 10.4 | 14.0 | 15.4 | 13.9 |
| 28-day Cs (MPa) | 32.2 | 37.3 | 39.7 | 40.7 |

TABLE 1.3
Composition of the concretes and strengths obtained with FA-3

| | | | | | FA-3 | | | |
|---|---|---|---|---|---|---|---|---|
| | FA-3 | | | | Dv97 = 10 μm | | | |
| test n° | 3-1 | 3-2 | 3-3 | 3-4 | 3-9 | 3-10 | 3-11 | 3-12 |
| Limestone (g) | 34.3 | 41.5 | 41.5 | 41.5 | 52.9 | 60.0 | 60.1 | 60.1 |
| Fly ash (g) | 134.1 | 125.7 | 117.4 | 109.0 | 134.1 | 125.7 | 117.4 | 109.0 |
| Anhydrite II (g) | 7.5 | 0.0 | 0.0 | 0.0 | 7.5 | 0.0 | 0.0 | 0.0 |
| Na₂SO₄ (g) | 0.0 | 8.4 | 16.8 | 25.1 | 0.0 | 8.4 | 16.8 | 25.1 |
| % Na₂Oeq total mix/(FA) | 3.6 | 6.6 | 10.0 | 13.9 | 3.6 | 6.6 | 10.0 | 13.9 |
| % SO₃ total mix/(KK) | 5.9 | 6.5 | 9.3 | 12.2 | 5.9 | 6.5 | 9.3 | 12.2 |
| PCP (Prelom 300) (g) | 3.1 | 3.1 | 2.9 | 2.1 | 4.4 | 4.7 | 4.7 | 4.4 |
| 24-hour Cs (MPa) | 8.9 | 13.3 | 14.3 | 14.1 | 11.0 | 14.1 | 14.8 | 14.4 |
| 28-day Cs (MPa) | 26.8 | 29.2 | 31.1 | 30.2 | 32.2 | 36.6 | 38.5 | 40.3 |

TABLE 1.4
Composition of the concretes and strengths obtained with FA-4

| | | | | | FA-4 | | | |
|---|---|---|---|---|---|---|---|---|
| | FA-4 | | | | Dv97 = 25 μm | | | |
| test n° | 4-1 | 4-2 | 4-3 | 4-4 | 4-5 | 4-6 | 4-7 | 4-8 |
| Limestone (g) | 28.5 | 34.3 | 34.3 | 34.3 | 49.4 | 55.2 | 55.2 | 55.2 |
| Fly ash (g) | 134.1 | 125.7 | 117.4 | 109.0 | 134.1 | 125.7 | 117.4 | 109.0 |
| Anhydrite II (g) | 6.1 | 0.0 | 0.0 | 0.0 | 6.1 | 0.0 | 0.0 | 0.0 |
| Na₂SO₄ (g) | 0.0 | 8.4 | 16.8 | 25.1 | 0.0 | 8.4 | 16.8 | 25.1 |
| % Na₂Oeq total mix/(FA) | 2.6 | 5.6 | 9.0 | 12.9 | 2.6 | 5.6 | 9.0 | 12.9 |
| % SO₃ total mix/(KK) | 5.9 | 6.5 | 9.3 | 12.2 | 5.9 | 6.5 | 9.3 | 12.2 |
| PCP (Prelom 300) (g) | 6.1 | 5.6 | 5.6 | 5.6 | 4.6 | 4.6 | 6.8 | 6.8 |
| 24-hour Cs (MPa) | 7.7 | 11.5 | 12.7 | 12.2 | 8.9 | 12.7 | 14.1 | 14.4 |
| 28-day Cs (MPa) | 25.2 | 28.9 | 30.2 | 30.1 | 26.4 | 31.4 | 34.2 | 35.2 |

FA-4
Dv97 = 10 μm

| test n° | 4-9 | 4-10 | 4-11 | 4-12 |
|---|---|---|---|---|
| Limestone (g) | 51.1 | 56.8 | 56.8 | 56.8 |
| Fly ash (g) | 134.1 | 125.7 | 117.4 | 109.0 |
| Anhydrite II (g) | 6.1 | 0.0 | 0.0 | 0.0 |
| Na₂SO₄ (g) | 0.0 | 8.4 | 16.8 | 25.1 |
| % Na₂Oeq total mix/(FA) | 2.6 | 5.6 | 9.0 | 12.9 |
| % SO₃ total mix/(KK) | 5.9 | 6.5 | 9.3 | 12.2 |
| PCP (Prelom 300) (g) | 6.5 | 6.5 | 6.5 | 6.5 |
| 24-hour Cs (MPa) | 7.9 | 11.5 | 13.0 | 12.9 |
| 28-day Cs (MPa) | 27.2 | 33.9 | 37.3 | 39.6 |

TABLE 2

| Na₂SO₄ (g) | 0 | 8.38 | 16.77 | 25.15 |
|---|---|---|---|---|
| 28-day Cs (MPa) | FA-1 | | | |
| Cs (standard)-Cs (standard)₀ | 0 | 3.2 | 4.8 | 4.5 |
| Cs (25 μm)-Cs (25 μm)₀ | 0 | 3.5 | 5.4 | 6.5 |
| 28-day Cs (MPa) | FA-2 | | | |
| Cs (standard)-Cs (standard)₀ | 0 | 2 | 5.5 | 4.7 |
| Cs (25 μm)-Cs (25 μm)₀ | 0 | 3.9 | 7.1 | 6.4 |
| Cs (10 μm)-Cs (10 μm)₀ | 0 | 5.1 | 7.5 | 8.5 |
| 28-day Cs (MPa) | FA-3 | | | |
| Cs (standard)-Cs (standard)₀ | 0 | 2.4 | 4.3 | 3.4 |
| Cs (10 μm)-Cs (10 μm)₀ | 0 | 4.4 | 6.3 | 8.1 |
| 28-day Cs (MPa) | FA-4 | | | |
| Cs (standard)-Cs (standard)₀ | 0 | 3.7 | 5 | 4.9 |
| Cs (25 μm)-Cs (25 μm)₀ | 0 | 5 | 7.8 | 8.8 |
| Cs (10 μm)-Cs (10 μm)₀ | 0 | 6.7 | 10.1 | 12.4 |

The Cs corresponded to the compressive strengths of the formulations comprising fly ash at different finenesses and with different quantities of alkali metal salt.

The standard fineness corresponded to the fineness of the fly ash before grinding.

The Cs₀ corresponded to the compressive strengths of the formulations comprising fly ash at different finenesses but without added alkali metal salt (tests 1-1, 2-1, 3-1 and 4-1 for the standard finenesses, 1-5, 2-5 and 4-5 for the Dv97 of 25 μm, 2-9, 3-9 and 4-9 for the Dv97 of 10 μm).

The difference between Cs and Cs₀ then showed the effect of the alkali metal salt by eliminating the effect of the fineness of the fly ash.

According to Table 2 above, it was possible to observe the unexpected effect that existed between the alkali metal salt and the fineness of the fly ash.

For example, the addition of 25.15 g of Na₂SO₄ in the composition comprising the FA-2 fly ash with a standard fineness, entrained an increase of 4.7 MPa between the formulation without the alkali metal salt and the formulation with the alkali metal salt.

Likewise, the addition of 25.15 g of Na₂SO₄ in the composition comprising the FA-2 fly ash having a Dv97 of 25 μm, entrained an increase of 6.4 MPa between the formulation without the alkali metal salt and the formulation with the alkali metal salt.

Likewise, the addition of 25.15 g of Na₂SO₄ in the composition comprising the FA-2 fly ash having Dv97 of 10 μm, entrained an increase of 8.5 MPa between the formulation without the alkali metal salt and the formulation with the alkali metal salt.

Moreover, when the values of the three previous paragraphs were used, the gain of compressive strength measured 28 days after the hydraulic composition was mixed was greater when the fineness of the fly ash was higher (better gain with a fly ash having a Dv97 of 25 μm, than a fly ash having a standard fineness).

The same finding was made for the three other tested fly ash.

Therefore, it was possible to conclude that the improvement of the compressive strength, due to the addition of alkali metal salt, was better when the fly ash used was finer.

1. A hydraulic binder comprising in parts by mass:
(a) 40 to 70 parts of a Portland clinker;
(b) 30 to 60 parts of fly ash;
(c) optionally up to 30 parts of an inorganic material other than clinker or than fly ash;
(d) 2.5 to 15 parts of an alkali metal salt expressed in parts of equivalent-Na₂O relative to 100 parts of fly ash; and
(e) 2 to 14 parts of sulphate expressed in parts of SO₃ relative to 100 parts of clinker;
the fly ash having a Dv97 less than or equal to 40 μm, and the sum of (a), (b) and (c) being equal to 100.

2. The hydraulic binder according to claim 1, wherein if the fly ash comprises more than 10% of reactive CaO, then the fly ash has a Dv97 greater than or equal to 15 μm.

3. The hydraulic binder according to claim 1, wherein the fly ash comprises less than 10% of reactive CaO and/or a quantity of SiO₂+Al₂O₃+Fe₂O₃ greater than 50%.

4. The hydraulic binder according to claim 3, wherein the fly ash comprises less than 10% of reactive CaO and/or a quantity of SiO₂+Al₂O₃+Fe₂O₃ greater than 70%.

5. The hydraulic binder according to claim 1, wherein the alkali metal salt comprises sodium sulphate.

6. A hydraulic composition, comprising water and a hydraulic binder according to claim 1.

7. A process for production of a hydraulic composition, comprising mixing water and Portland clinker, fly ash having a Dv97 less than or equal to 40 μm, optionally an inorganic material other than clinker or than fly ash, an alkali metal salt and sulphate in quantities as defined in claim 1.

8. A shaped object for the construction field comprising a hydraulic binder according to claim 1.
